(19) United States
(12) Patent Application Publication
(10) Pub. No.: US 2017/0284287 A1
(43) Pub. Date: Oct. 5, 2017

(54) Electro-Hydrogen Driving Unit

(71) Applicant: Manivasan Nathamani, Winnipeg (CA)

(72) Inventor: Manivasan Nathamani, Winnipeg (CA)

(21) Appl. No.: 15/473,552

(22) Filed: Mar. 29, 2017

Related U.S. Application Data
(60) Provisional application No. 62/314,501, filed on Mar. 29, 2016.

(51) Int. Cl. F02B 43/10; B60L 11/18; H01M 8/04082; F02M 21/02; C25B 1/04; H01M 8/0656

(52) U.S. Cl. CPC F02B 43/10; C25B 1/04; H01M 8/0656; H01M 8/04201; F02M 21/0206; B60L 11/1883; H01M 2250/20; F02B 2043/106

(57) ABSTRACT

An electro-hydrogen driving unit that can be integrated into an automobile includes a power source, a water supply, a hydrogen production unit, a hydrogen storage unit, a power conversion unit, and a driving unit. When parked and charging, the power source and the water supply are used to generate hydrogen at the hydrogen production unit. The generated hydrogen is stored at the hydrogen storage unit at a high pressure. When the automobile is running, the power conversion unit uses the stored hydrogen to produce electricity which spins an electric motor of the driving unit. The power conversion unit can be a fuel cell that draws hydrogen and produces electricity. In another instance, the power conversion unit can be a combination of an internal combustion engine and a generator.

The current application claims a priority to the U.S. Provisional Patent application Ser. No. 62/314,501 filed on Mar. 29, 2016.

### FIELD OF THE INVENTION

The present invention relates generally to automobiles utilizing alternative energy sources. More specifically, the present invention introduces a method of using electricity and Hydrogen in the process of charging and driving an automobile.

### BACKGROUND OF THE INVENTION

Environmental concerns, high oil prices, and the potential for peak oil where the maximum rate of extraction of petroleum is reached, has resulted in the rise of developing alternative fuel automobiles. Electric automobiles and hydrogen driven automobiles are some of the well-known types of alternative fuel automobiles. Even though there are many advantages to these hydrogen and electricity driven automobiles, there are certain drawbacks too.

When considering electrically driven automobiles, rechargeable batteries are used to store electrical energy. The toxic nature of the batteries can be harmful to the ecosystem. The high price of the batteries limits the number of users who can afford such a system. The limited range is another disadvantage prevalent with existing electric cars.

Hydrogen driven automobiles use hydrogen as their onboard fuel for motive power. Generally, the hydrogen required for powering the automobile is provided through a fuel station. Currently, only a limited number of such fuel stations are available throughout the United States. Setting up and maintaining a network of such fuel stations can be financially disadvantageous. On the other hand, electrolysis plants can also be used to generate hydrogen. However, since these electrolysis plants cannot be fitted into an automobile the need for a method that can produce hydrogen within the car is clear.

The objective of the present invention is to address the aforementioned issues. In doing so, the present invention introduces a system in which the automobile is charged using electricity, produces hydrogen, and uses hydrogen as a medium for storing electrical energy. To produce hydrogen, the present invention introduces a miniature electrolysis hydrogen producing plant as part of the automobile. By utilizing the present invention, the use of carbon technologies can be minimized. Additionally, the need to transport fuel across greater distances is also resolved by utilizing the present invention.

### BRIEF DESCRIPTION OF THE DRAWINGS

FIG. 1 is a block diagram illustrating the general process flow of the present invention.

FIG. 2 is a detailed block diagram of the present invention, wherein a fuel cell is used in the power conversion unit.

FIG. 3 is a detailed block diagram of the present invention, wherein an internal combustion engine and a generator is used in the power conversion unit.

FIG. 4 is a detailed block diagram of the present invention, wherein the internal combustion engine is directly connected to a transmission unit of the automobile.

FIG. 5 is a detailed block diagram of the present invention, wherein a reversible fuel cell is used.

### DETAIL DESCRIPTIONS OF THE INVENTION

All illustrations of the drawings are for the purpose of describing selected versions of the present invention and are not intended to limit the scope of the present invention.

The present invention introduces a system that uses alternative energy source to drive an automobile. In particular, the present invention introduces a system that uses electricity for charging the automobile, produces hydrogen, and then uses the produced hydrogen to generate electricity that ultimately drives the automobile. The present invention, which is mounted onto the automobile, helps eliminate the use of batteries that are toxic and expensive. By utilizing the present invention, the need to minimize the use of carbon technologies is addressed.

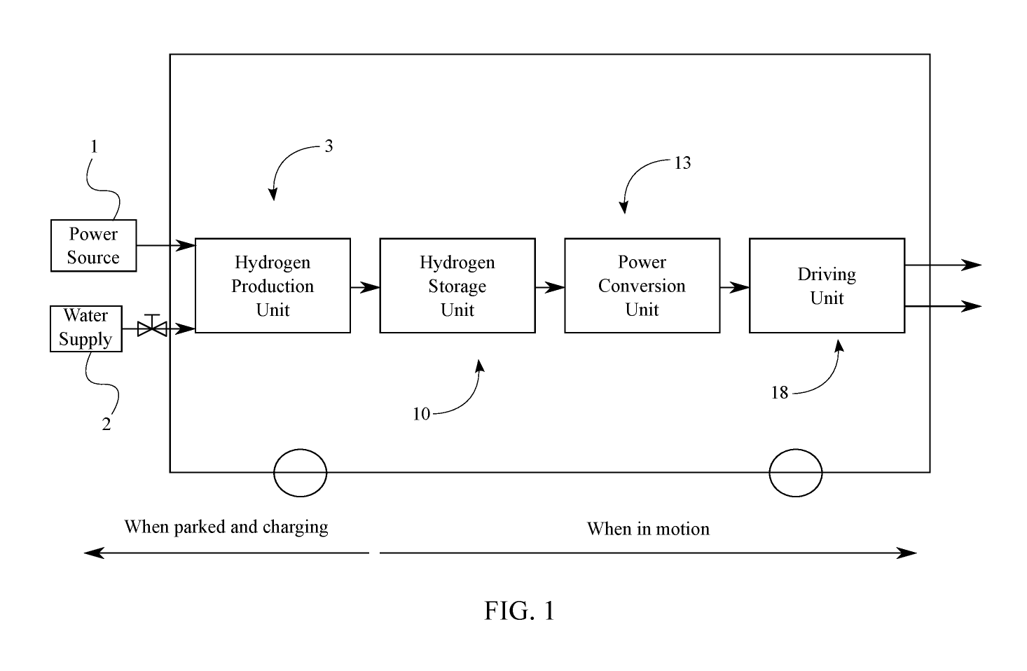

The present invention is designed to produce hydrogen with the use of electricity, store the produced hydrogen at a high pressure, and then utilize the stored hydrogen in the process of driving the automobile with electricity. Producing hydrogen and storing hydrogen occurs when the automobile the present invention is being used on is parked and charging. When the automobile is in motion, the stored hydrogen is used to generate electricity. As illustrated in FIG. 1, the present invention comprises a power source 1, a water supply 2, a hydrogen production unit 3, a hydrogen storage unit 10, a power conversion unit 13, and a driving unit 18. The hydrogen production unit 3 utilizes the power source 1 and the water supply 2 to produce hydrogen. Therefore, the power source 1 is electrically connected to the hydrogen production unit 3 and the water supply 2 is in fluid communication with the hydrogen production unit 3. The generated hydrogen is then transferred to the hydrogen storage unit 10. To do so, the hydrogen production unit 3 is connected to the hydrogen storage unit 10 which is configured to receive the generated hydrogen. The stored hydrogen is then transferred to the power conversion unit 13 which utilizes hydrogen to generate electricity. To do so, the hydrogen storage unit 10 is in fluid communication with the power conversion unit 13. To drive the car, the power conversion unit 13 is operatively coupled with the driving unit 18.

The hydrogen production unit 3 produces hydrogen when the automobile is charging. During the charging process, electricity is directly drawn from an electrical power grid or other electricity source and then later adjusted to accommodate the components of the present invention. The water supply 2 provides the water needed to produce hydrogen via electrolysis. To do so, the hydrogen production unit 3 comprises a water distiller 4, an electric power converter 5, an electrolyzer 6, at least one hydrogen filter 7, and a compressor 8. The electric power converter 5 is used to produce the appropriate electrical power for hydrogen production. As an example, if the power source 1 is a 120-Volt alternating current (AC) supply as in the preferred embodiment of the present invention, the electric power converter 5 converts the 120-Volt AC power to a direct current (DC) power supply. To do so, the electric power converter 5 is electrically connected to the power source 1. The DC power supply is then provided to the water distiller 4, which is used to distill water from the water supply 2, and the electrolyzer 6, which is used to produce Hydrogen. To do so, the electric power converter 5 is electrically connected to the water distiller 4 and the electrolyzer 6.

The DC power supply generated by the electric power converter 5 is connected to two electrodes of the electrolyzer 6. The two electrodes, which are preferably made of platinum, stainless steel, iridium, or a similar inert metal, is placed in the water which was distilled by the water distiller 4. To provide distilled water for electrolysis, the water supply 2 is in fluid communication with the electrolyzer 6 through the water distiller 4. The electrolysis process produces hydrogen at the cathode and oxygen at the anode. In ideal faradic efficiency, the amount of hydrogen generated is twice as the amount of oxygen. Moreover, the amount of hydrogen and the amount of oxygen generated is proportional to the total electrical charge conducted by the solution. The present invention releases the generated oxygen to the atmosphere and proceeds to store the generated hydrogen in the hydrogen storage unit 10.

One embodiment of the present invention further comprises an electrolyte concentration feeder 9 which is in fluid communication with the water distiller 4. The electrolyte concentration feeder 9 is beneficial if the electrolyzer 6 is unable to function solely using of distilled water. In such instances, the electrolyte concentration feeder is used to add a required amount of electrolyte concentrate to the distilled water which is later used in electrolysis.

To remove impurities and moisture, the generated hydrogen is sent through the at least one hydrogen filter 7. To do so, the electrolyzer 6 is in fluid communication with the at least one hydrogen filter 7. The filtered hydrogen is then transferred towards the hydrogen storage unit 10. In the process of doing so, the generated hydrogen is sent through the compressor 8 which is in fluid communication with the hydrogen filter 7. The compressor 8, which is also electrically connected to the electric power converter 5, aids in the process of storing the generated hydrogen in the hydrogen storage unit 10 at a high pressure.

The compressor 8 is in fluid communication with the hydrogen storage unit 10 so that the compressed hydrogen flows through to the hydrogen storage unit 10 which comprises a pressure sensor 11 and at least one storage tank 12. The compressor 8 ensures that the generated hydrogen is stored within the at least one storage tank 12 at a high pressure. The pressure sensor 11 is used to monitor the pressure of the hydrogen stored in the at least one storage tank 12. To do so, the pressure sensor 11 is operatively coupled with the at least one storage tank 12. The number of storage tanks can vary in different embodiments of the present invention. In the preferred embodiment of the present invention, one storage tank 12 is used for storing the generated hydrogen at a high pressure. The pressure sensor 11 is designed to stop the production of hydrogen when the at least one storage tank 12 reaches a predetermined pressure level.

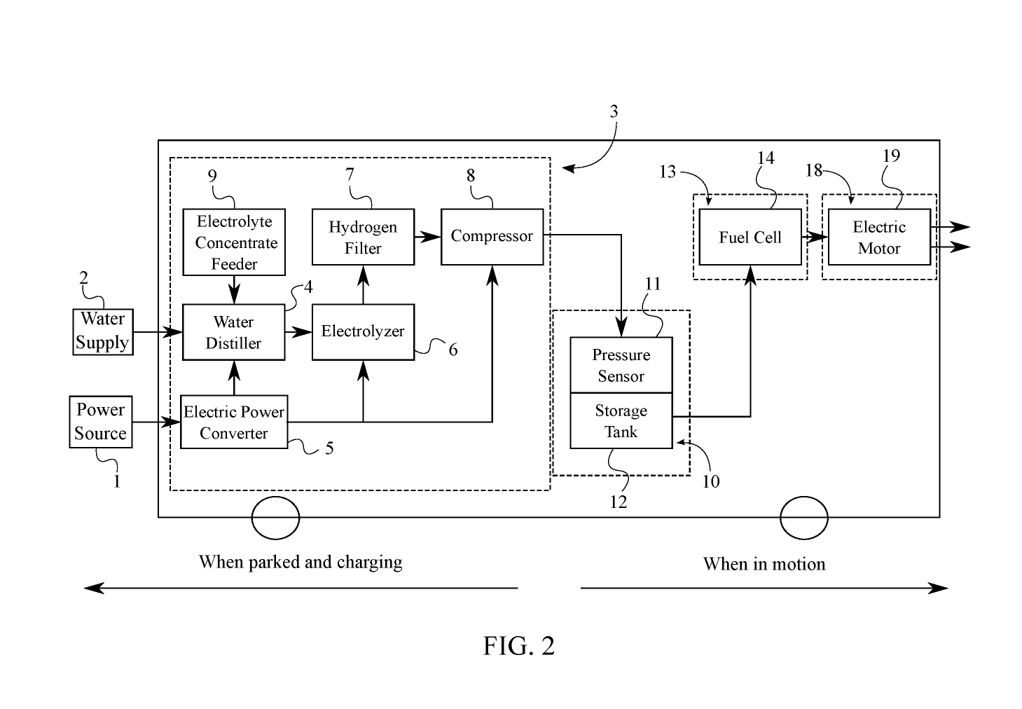

The power conversion unit 13 consumes the stored hydrogen as fuel when the automobile is running. To convert the stored hydrogen into electricity, the hydrogen storage unit 10 is in fluid communication with the power conversion unit 13. Therefore, the power conversion unit 13 takes the stored hydrogen as the input and outputs electricity which is used for driving the automobile. As illustrated in FIG. 2, in one embodiment of the present invention, the power conversion unit 13 comprises a fuel cell 14 which draws hydrogen from the hydrogen storage unit 10 and produces electricity. To do so, the hydrogen storage unit 10 is connected to the fuel cell 14 which is configured to receive hydrogen from the hydrogen storage unit 10. When hydrogen flows into the fuel cell 14, a chemical reaction at the anode strips electrons from the hydrogen atoms. Thus, the hydrogen atoms are ionized and carry a positive charge. The negatively charged electrons provide the required current. The fuel cell 14 is specifically used when hydrogen of high purity is generated by the electolyzer.

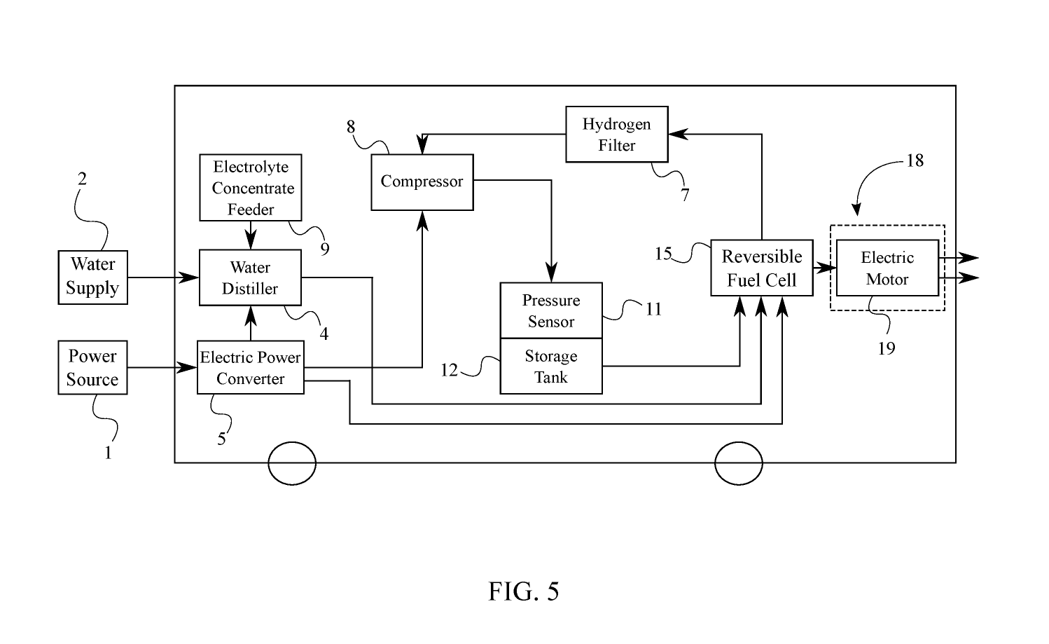

As illustrated in FIG. 5, in another embodiment of the present invention, the fuel cell 14 can be a reversible fuel cell 15. In the forward mode of the reversible fuel cell 15, when the automobile is in motion, hydrogen and oxygen is taken as the input and electricity and water is produced as the output. In the reverse mode, electricity and water is taken as the input and hydrogen and oxygen are produced as the output when the automobile is parked and charging. In such instances, the electric power converter 5 is electrically connected to the reversible fuel cell 15. Thus, the reversible fuel cell 15 fulfills the functionalities of the electrolyzer 6 as well as an electricity generator 17.

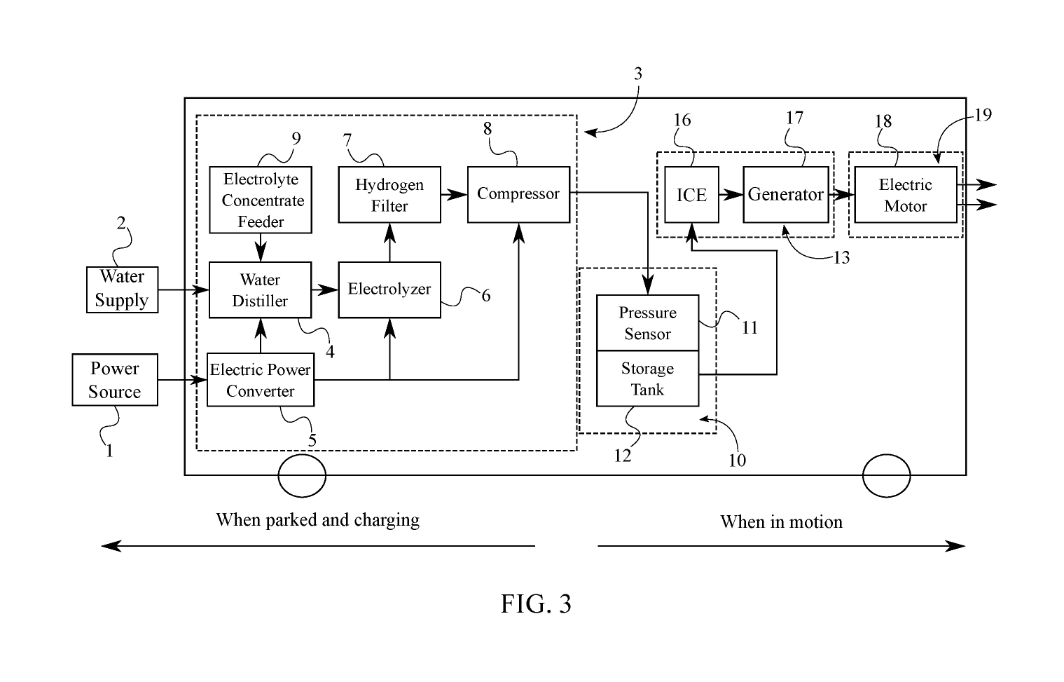

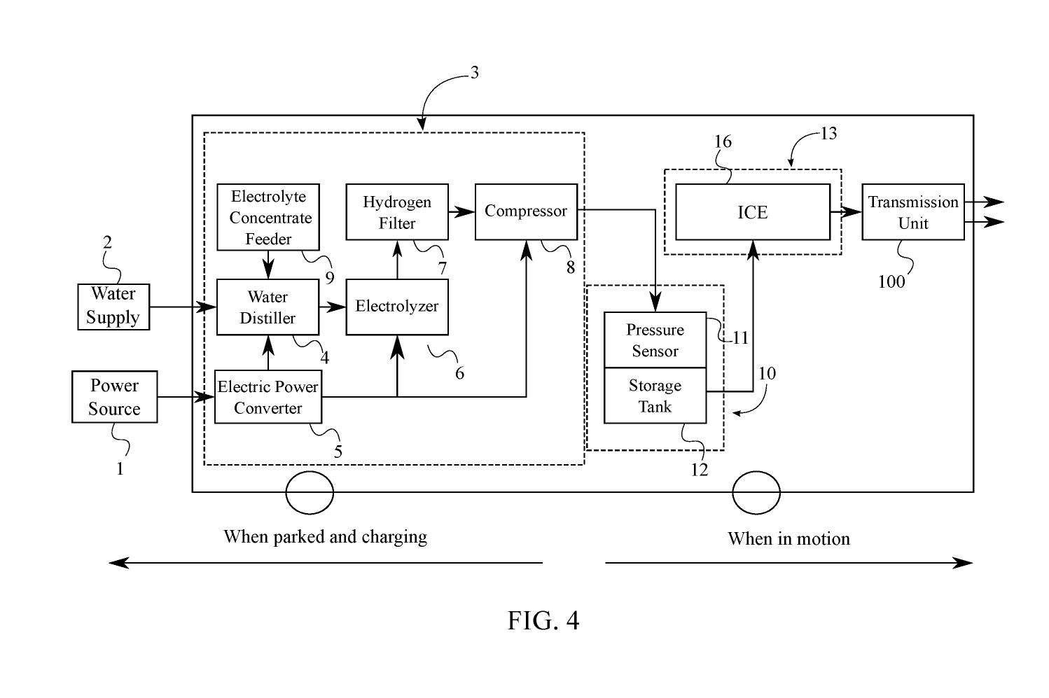

As illustrated in FIG. 3, in an alternative embodiment of the present invention, the power conversion unit 13 comprises an internal combustion engine (ICE) 16 and a generator 17. The ICE 16 draws hydrogen from the hydrogen storage unit 10, burns the hydrogen, then uses the hydrogen to spin the generator 17. To do so, the ICE 16 is operatively coupled with the generator 17, wherein the generator 17 is mechanically driven by the ICE 16. The combination of the ICE 16 and the generator 17 is beneficial when the hydrogen produced at the electrolyzer 6 is not of high purity. As illustrated in FIG. 4, in another embodiment, the ICE 16 is directly coupled to the wheels of the automobile in which the present invention is being used on, via a transmission unit 100 of the power conversion unit 13. In such instances, the ICE 16 is operatively coupled with the transmission unit 13 so that the transmission unit 13 is mechanically driven by the ICE 16. In other words, the torque generated by the ICE 16 is used for driving the automobile the present invention is being used on.

As discussed before, the power conversion unit 13 is operatively coupled to the driving unit 18. The driving unit 18 comprises an electric motor 19 that utilizes the electricity generated at the power conversion unit 13 to drive the automobile. To do so, the power conversion unit 13 is electrically connected to the electric motor 19. If the fuel cell 14 is being used, the fuel cell 14 is electrically connected to the electric motor 19. On the other hand, if the ICE 16 and the generator 17 combination is used, the generator 17 is electrically connected to the electric motor 19. Thus, the electric motor 19 drives the wheels of the automobile the present invention is being used on.

Although the invention has been explained in relation to its preferred embodiment, it is to be understood that many other possible modifications and variations can be made without departing from the spirit and scope of the invention as hereinafter claimed.

What is claimed is:

1. An electro-hydrogen driving unit comprises:
a power source;
a water supply;
a hydrogen production unit;
a hydrogen storage unit;
a power conversion unit;
a driving unit;
the power source being electrically connected to the hydrogen production unit;
the water supply being in fluid communication with the hydrogen production unit;
the hydrogen production unit being connected to the hydrogen storage unit;
the hydrogen storage unit is in fluid communication with the power conversion unit; and
the power conversion unit being operatively coupled with the driving unit.

2. The electro-hydrogen driving unit as claimed in claim 1 further comprises:
the hydrogen production unit comprises a water distiller, an electric power converter, an electrolyzer, at least one hydrogen filter, and a compressor;
the water supply being in fluid communication with the electrolyzer through the water distiller;
the electric power converter being electrically connected to the power source;
the electric power converter being electrically connected to the water distiller, the electrolyzer, and the compressor;
the electrolyzer being in fluid communication with the at least one hydrogen filter; and
the hydrogen filter being in fluid communication with the compressor.

3. The electro-hydrogen driving unit as claimed in claim 2 further comprises:
an electrolyte concentrate feeder; and
the electrolyte concentrate feeder being in fluid communication with the water distiller.

4. The electro-hydrogen driving unit as claimed in claim 1 further comprises:
the hydrogen storage unit comprises a pressure sensor and at least one storage tank;
the pressure sensor being operatively coupled with the at least one storage tank; and
a compressor of the hydrogen production unit being in fluid communication with the at least one storage tank, wherein the compressor stores hydrogen at a high pressure within the at least one storage tank.

5. The electro-hydrogen driving unit as claimed in claim 1 further comprises:
the power conversion unit comprises a fuel cell; and
the hydrogen storage unit being connected to the fuel cell, wherein the fuel cell is configured to receive hydrogen from the hydrogen storage unit.

6. The electro-hydrogen driving unit as claimed in claim 5, wherein the fuel cell is a reversible fuel cell.

7. The electro-hydrogen driving unit as claimed in claim 1 further comprises:
the power conversion unit comprises an internal combustion engine (ICE) and a generator; and
the ICE being operatively coupled with the generator, wherein the generator is mechanically driven by the ICE.

8. The electro-hydrogen driving unit as claimed in claim 1 further comprises:
the power conversion unit comprises an internal combustion engine (ICE) and a transmission unit; and
the ICE being operatively coupled with the transmission unit, wherein the transmission unit is mechanically driven by the ICE.

9. The electro-hydrogen driving unit as claimed in claim 1 further comprises:
the driving unit comprises an electric motor; and
the power conversion unit being electrically connected to the electric motor.

10. The electro-hydrogen driving unit as claimed in claim 1, wherein the power supply is a 120 Volt alternating current (AC) power supply.
